(19) United States
(12) Patent Application Publication
(10) Pub. No.: US 2024/0037095 A1
(43) Pub. Date: Feb. 1, 2024

(54) DYNAMIC DIMENSION BINDING FOR WORKBOOK ELEMENTS

(71) Applicant: SIGMA COMPUTING, INC., San Francisco, CA (US)

(72) Inventors: MAX H. SEIDEN, SAN FRANCISCO, CA (US); DEEPANSHU UTKARSH, SAN FRANCISCO, CA (US)

(21) Appl. No.: 17/877,187

(22) Filed: Jul. 29, 2022

(51) Int. Cl. G06F 16/242; G06F 16/28; G06F 16/26

(52) U.S. Cl. CPC G06F 16/2428; G06F 16/283; G06F 16/26

(57) ABSTRACT

Dynamic dimension binding for workbook elements including presenting, by a workbook manager, a workbook element on a GUI of a client computing system, wherein the workbook element presents a data set from a cloud-based data warehouse; receiving, by the workbook manager via the GUI, a formula that includes a reference to a channel within the workbook element, wherein the channel of the workbook element is bound to a first dimension of the data set; detecting, by the workbook manager, that the formula references the channel within the workbook element; and rewriting by the workbook manager, the formula by replacing the reference to the channel within the workbook element with the first dimension bound to the channel.

### BACKGROUND

### Field of the Invention

The field of the invention is data processing, or, more specifically, methods, apparatus, and products for dynamic dimension binding for workbook elements.

### Description Of Related Art

Modern businesses may store large amounts of data in remote databases within cloud-based data warehouses. This data may be accessed using database statement languages, such as structured query language (SQL). Manipulating the data stored in the database may require constructing complex queries beyond the abilities of most users. Further, composing and issuing database queries efficiently may also be beyond the abilities of most users.

### SUMMARY

Methods, systems, and apparatus for dynamic dimension binding for workbook elements including presenting, by a workbook manager, a workbook element on a GUI of a client computing system, wherein the workbook element presents a data set from a cloud-based data warehouse; receiving, by the workbook manager via the GUI, a formula that includes a reference to a channel within the workbook element, wherein the channel of the workbook element is bound to a first dimension of the data set; detecting, by the workbook manager, that the formula references the channel within the workbook element; and rewriting by the workbook manager, the formula by replacing the reference to the channel within the workbook element with the first dimension bound to the channel.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for dynamic dimension binding for workbook elements according to embodiments of the present invention.

FIG. 2 sets forth a block diagram of an example system configured for dynamic dimension binding for workbook elements according to embodiments of the present invention.

FIG. 3 sets forth a block diagram of an example system configured for dynamic dimension binding for workbook elements according to embodiments of the present invention.

FIG. 4 sets forth a flow chart illustrating an exemplary method for dynamic dimension binding for workbook elements according to embodiments of the present invention.

FIG. 5 sets forth a flow chart illustrating an exemplary method for dynamic dimension binding for workbook elements according to embodiments of the present invention.

FIG. 6 sets forth a flow chart illustrating an exemplary method for dynamic dimension binding for workbook elements according to embodiments of the present invention.

### DETAILED DESCRIPTION

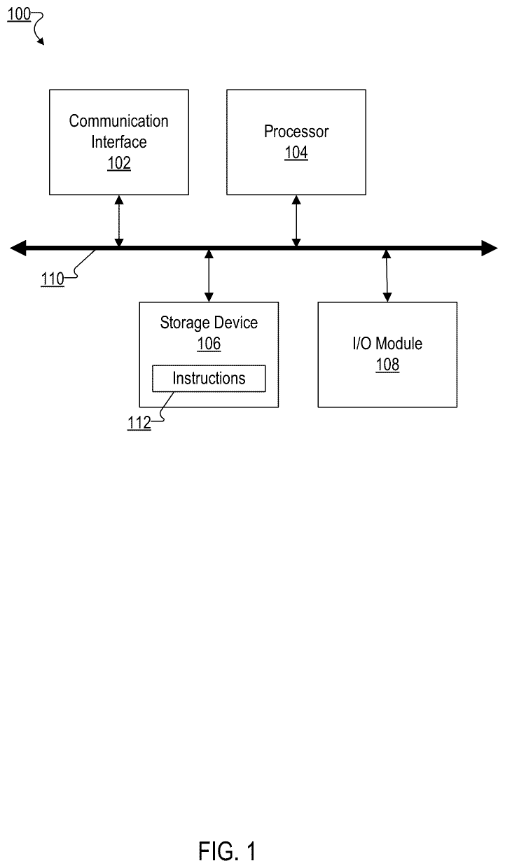

Example methods, apparatus, and products for dynamic dimension binding for workbook elements in accordance with embodiments of the present disclosure are described with reference to the accompanying drawings, beginning with FIG. 1. FIG. 1 illustrates an exemplary computing device 100 that may be specifically configured to perform one or more of the processes described herein. As shown in FIG. 1, computing device 100 may include a communication interface 102, a processor 104, a storage device 106, and an input/output (“I/O”) module 108 communicatively connected one to another via a communication infrastructure 110. While an exemplary computing device 100 is shown in FIG. 1, the components illustrated in FIG. 1 are not intended to be limiting. Additional or alternative components may be used in other embodiments. Components of computing device 100 shown in FIG. 1 will now be described in additional detail.

Communication interface 102 may be configured to communicate with one or more computing devices. Examples of communication interface 102 include, without limitation, a wired network interface (such as a network interface card), a wireless network interface (such as a wireless network interface card), a modem, an audio/video connection, and any other suitable interface.

Processor 104 generally represents any type or form of processing unit capable of processing data and/or interpreting, executing, and/or directing execution of one or more of the instructions, processes, and/or operations described herein. Processor 104 may perform operations by executing computer-executable instructions 112 (e.g., an application, software, code, and/or other executable data instance) stored in storage device 106.

Storage device 106 may include one or more data storage media, devices, or configurations and may employ any type, form, and combination of data storage media and/or device. For example, storage device 106 may include, but is not limited to, any combination of non-volatile media and/or volatile media. Electronic data, including data described herein, may be temporarily and/or permanently stored in storage device 106. For example, data representative of computer-executable instructions 112 configured to direct processor 104 to perform any of the operations described herein may be stored within storage device 106. In some examples, data may be arranged in one or more databases residing within storage device 106.

I/O module 108 may include one or more I/O modules configured to receive user input and provide user output. I/O module 108 may include any hardware, firmware, software, or combination thereof supportive of input and output capabilities. For example, I/O module 108 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 108 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 100.

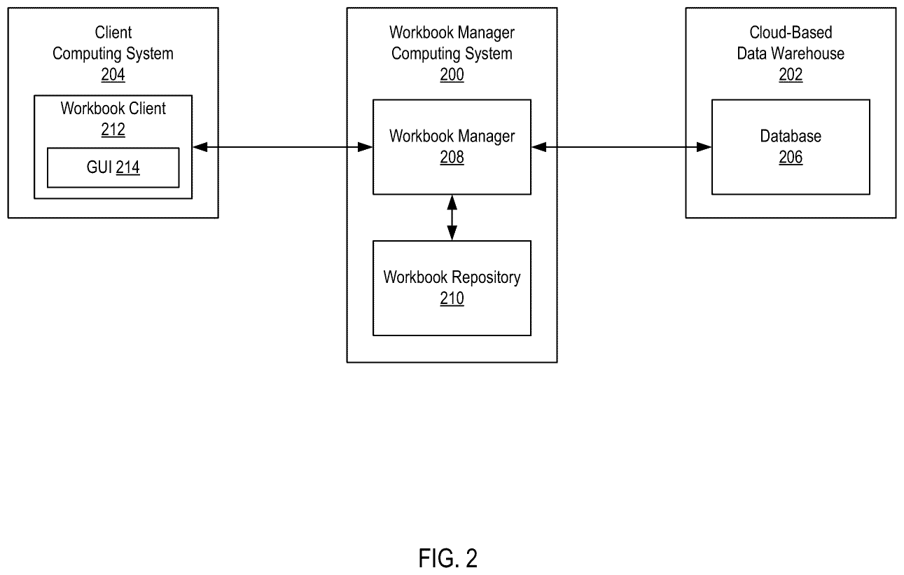

For further explanation, FIG. 2 illustrates an exemplary block diagram depicting an exemplary system for dynamic dimension binding for workbook elements according to embodiments of the present invention. As shown in FIG. 2, the system includes a workbook manager computing system 200, a cloud-based data warehouse 202, and a client computing system 204. The workbook manager computing system 200 includes a workbook manager 208 and a workbook repository 210. The client computing system 204 includes a workbook client 212 with a graphical user interface (GUI) 214. The cloud-based data warehouse 202 includes a database 206.

The workbook manager 208 is hardware, software, or an aggregation of hardware and software configured to present a data set within a workbook on a client computing system 204 via the workbook client 212. The workbook manager 208 retrieves the data set from the database 206 by issuing a database statement to the cloud-based data warehouse 202 requesting the data set. In response, the cloud-based data warehouse 202 sends query results including the data set to the workbook manager 208. Once the query results are received, the data set is then organized according to the workbook metadata to generate the workbook. The workbook is then sent to a workbook client 212 on the client computing system 204 for presentation to a client. The workbook manager 208 may reside on a workbook manager computing system 200 between each client system and the cloud-based data warehouse 202.

The cloud-based data warehouse 202 stores and manages client data on behalf of the client. The client (e.g., via the client computing system 204) accesses the data via the workbook manager 208, which organizes and analyzes the data as data sets within a workbook. The workbook manager 208 may access the client data from the cloud-based data warehouse 202 using credentials supplied by the client.

A workbook is a presentation of a data set from a cloud-based data warehouse 202. A workbook may include a collection of graphical elements and organizing mechanism for the data set. Each workbook is a combination of a data set from the cloud-based data warehouse 202 and workbook metadata that describes the organization of the data set for presentation to a user. The workbook metadata may also include a description of the data set sufficient to generate a database statement targeting the cloud-based data warehouse. A workbook may include multiple elements, such as a visualization or spreadsheet structure. For example, a workbook may include a spreadsheet structure presenting data points from a data set and an accompanying visualization may present a graph of the data points. Such workbooks may be stored in the workbook repository 210. Workbooks are described in further detail below.

The workbook client 212 is a part of the workbook manager 208 and works in concert with the workbook manager 208 to present a workbook on a client computing system 204. The workbook client 212 may perform local processing of changes made to the workbook and/or the data set. The workbook client 212 may be an application executing within a web browser. The workbook client 212 may be part of an Internet application that includes the workbook manager 208 and is hosted on the workbook manager computing system 200.

The GUI 214 is a visual presentation configured to present data sets and workbooks to a client. The GUI 214 may receive requests from a user for data sets from the database 206. The GUI 214 may also present to the user the ability to add a new row into a data set or table and enter values for each column of the new row. The GUI 214 may be displayed on client computing system 204 (e.g., on a system display or mobile touchscreen).

The database 206 is a collection of data and a management system for the data. A data set is a collection of data (such as a table) from the database 206. Data sets may be organized into columns and rows (also referred to as records). The particular columns, rows, and organization of the columns and rows that make up a data set may be specified in the database statement requesting the data set. Data sets may be sent from the cloud-based data warehouse 202 in response to a database statement (also referred to as a query). Accordingly, data sets retrieved in response to a database statement may be referred to as query results. The database statement may be a structured query language statement.

The workbook manager 208 and workbook clients 212a, 212b may exchange information using state specifications. A state specification is a collection of data describing inputs into the GUI 214. The state specification may include manipulations of GUI elements within the GUI 214 along with data entered into the GUI 214 by a user of the client computing system 204. Such manipulations and data may indicate requests for and manipulations of data sets. Such manipulations and data may also indicate requests to edit an existing row or create a new row and values for that row. The state specification may be a standard file format used to exchange data in asynchronous browser-server communication. For example, the state specification may be a JavaScript Object Notation specification. The state specification may also include descriptions of elements that are used to apply changes to the data set. Such elements may include filters applied to an element of the workbook, the hierarchical level of an element of the workbook, joins performed within an element of the workbook, exposable parameters in an element of the workbook, and security for the workbook.

The workbook manager 208 may use the state specification as input to compile a database statement. This database statement generation process may begin with state specification being converted into an abstract syntax tree. The abstract syntax tree may then be canonicalized into a canonicalized hierarchy. The canonicalized hierarchy may then be linearized into the workbook algebra. The workbook algebra may then be lowered into a relational algebra, which may then be lowered into the database statement.

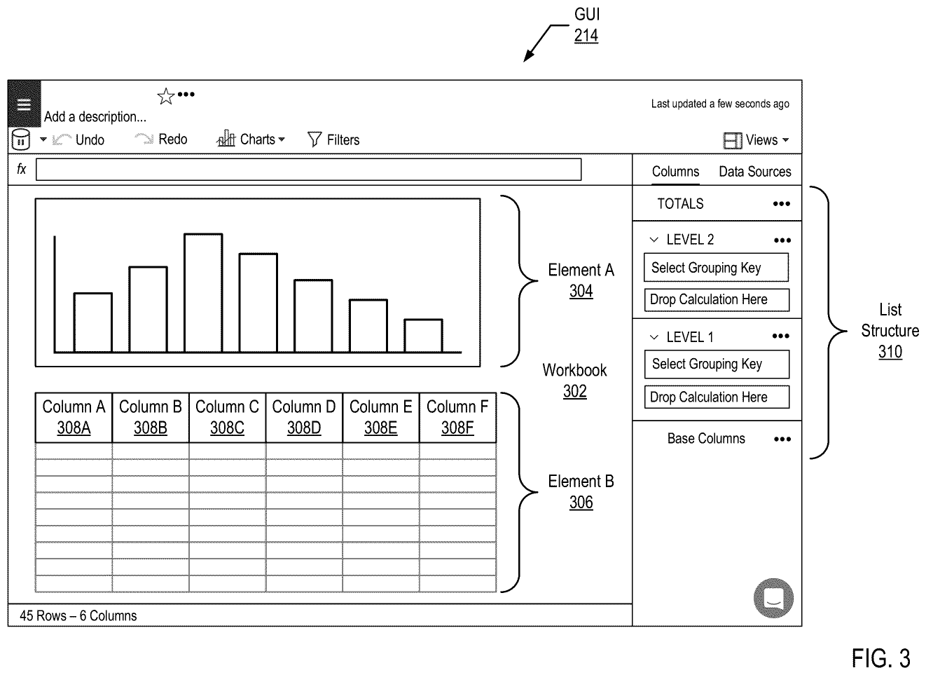

FIG. 3 shows an exemplary GUI for dynamic dimension binding for workbook elements according to embodiments of the present invention. As shown in FIG. 3, the exemplary GUI 214 includes a workbook 302 and a list structure 310. The workbook 302 includes two elements (element A 304, element B 306). Element A 304 is a visualization 304 and element B 306 is a spreadsheet structure 306 (shown as empty rows) with six columns (column A 308a, column B 308b, column C 308c, column D 308d, column E 308e, column F 308f).

The workbook 302 is a collection of graphical elements and organizing mechanism for a data set. The workbook may present a data set retrieved by the workbook manager from a cloud-based data warehouse. The data set may then be organized based on the workbook metadata retrieved from the workbook repository. As shown in FIG. 3, the workbook 302 includes two workbook elements. Element A 304 is a visualization of a data set and element B 306 is a spreadsheet structure. The visualization is a graphical element that conveys relationships between data in the data set. The visualization may include, for example, graphs, charts, or maps. The spreadsheet structure is a presentation of a data set (such as a table) from a database on a data warehouse. The spreadsheet structure displays rows of data organized by columns (column A 308a, column B 308b, column C 308c, column D 308d, column E 308e, column F 308f). The columns delineate different categories of the data in each row. One or more columns may be calculation columns that include calculation results using other columns in the spreadsheet structure based on a formula received from the client. Both the visualization and the spreadsheet structure may include dynamic elements and be configured to interact with a client using the client computing system 204 via the GUI 214. Each workbook element 304, 306 may use a data set unique to that workbook element or use a data set shared by at least one workbook element.

Each workbook element 304, 306 is built by binding dimensions of the data set to channels of the workbook element 304, 306. A dimension of the data set refers to a group of values, rows, or columns that share a characteristic. For example, a dimension may be all values in the data set from a particular column, all rows in the data set that share a value for a particular column, all columns in the data set that share a value for a particular row, etc. A channel of the workbook element 304, 306 refers to aspect of the workbook element that is assignable to a dimension. Channels of a spreadsheet structure may include columns or rows (e.g., a column of the data set may be bound to a particular column location within the visual presentation of the spreadsheet structure). Channels of visualizations may include, for example, x-axis, y-axis, or color. For example, a column of a data set may be bound to the x-axis of a bar chart.

The list structure 310 is a graphical element used to define and organize the workbook elements, such as hierarchical relationships between the columns (column A 308a, column B 308b, column C 308c, column D 308d, column E 308e, column F 308f) of the of the spreadsheet structure. The term “hierarchical relationship” refers to subordinate and superior groupings of columns. For example, a database may include rows for an address book, and columns for state, county, city, and street. A data set from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The list structure 310 may present a dimensional hierarchy to the user. Specifically, the list structure 310 may present levels arranged hierarchically across at least one dimension. Each level within the list structure 310 is a position within a hierarchical relationship between columns (column A 308a, column B 308b, column C 308c, column D 308d, column E 308e, column F 308f) of the spreadsheet structure element 306. The keys within the list structure 310 identify the one or more columns that are the participants in the hierarchical relationship. Each level may have more than one key.

One of the levels in the list structure 310 may be a base level. Columns selected for the base level provide data at the finest granularity. One of the levels in the list structure 310 may be a totals or root level. Columns selected for the totals level provide data at the highest granular level. For example, the totals level may include a field that calculates the sum of each row within a single column of the entire data set (i.e., not partitioned by any other column).

The GUI 214 may enable a user to drag and drop columns (column A 308a, column B 308b, column C 308c, column D 308d, column E 308e, column F 308f) into the list structure 310. The order of the list structure 310 may specify the hierarchy of the columns relative to one another. A user may be able to drag and drop the columns in the list structure 310 at any time to redefine the hierarchical relationship between columns. The hierarchical relationship defined using the columns selected as keys in the list structure 310 may be utilized in charts such that drilling down (e.g., double click on a bar), enables a new chart to be generated based on a level lower in the hierarchy.

The GUI 214 may also include a mechanism for a user to request a data set from a database to be presented as a workbook element in a workbook 302. Such a mechanism may be part of the interactivity of the workbook 302. Specifically, a user may manipulate a workbook (e.g., by dragging and dropping columns or rows, resorting columns or rows, manipulating a graph etc.) and, in response, the GUI 214 may generate a request (e.g., in the form of a state specification) for a data set and send the request to the workbook manager 126. Such a mechanism may also include a direct identification of the rows and columns of a database table that a user would like to access (e.g., via a selection of the rows and columns in a dialog box). The GUI 214 may also include a mechanism for a user to create a new table on the database, add rows to a table, and move rows within the table.

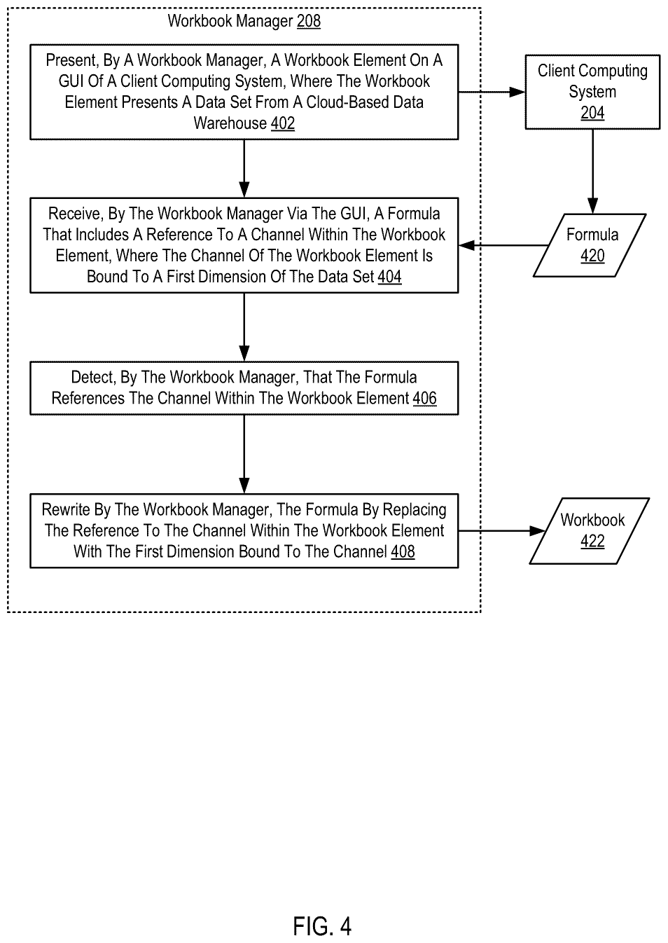

For further explanation, FIG. 4 sets forth a flow chart illustrating an exemplary method for dynamic dimension binding for workbook elements according to embodiments of the present invention. The method of FIG. 4 includes presenting 402, by a workbook manager 208, a workbook element on a GUI of a client computing system 204, wherein the workbook element presents a data set from a cloud-based data warehouse. Presenting 402 a workbook element on the GUI of the client computing system 204 may be carried out by organizing the data set from the cloud-based data warehouse into the workbook element according to the workbook. The workbook may be a preexisting workbook created by a client using the client computing system 204 or may be a default workbook used after the data set is selected by the client. The workbook element may be a visualization or spreadsheet structure.

The method of FIG. 4 also includes receiving 404, by the workbook manager 208 via the GUI, a formula 420 that includes a reference to a channel within the workbook element, wherein the channel of the workbook element is bound to a first dimension of the data set. Receiving 404, via the GUI, the formula 420 that includes the reference to the channel within the workbook element may be carried out by detecting that the client on the client computing system 204 has manipulated elements of the GUI and/or submitted data using the GUI such that the generation of an instruction including the formula 420 is triggered, and the formula 420 is sent to the workbook manager 208. The formula 420 may be received in the form of a state specification from the GUI.

The formula 420 may be received as part of an instruction to create an additional data visualization, either within the same workbook element or as an additional workbook element. For example, the formula 420 may be for a new column in a spreadsheet structure workbook element. The reference to the channel within the workbook element may be a description of the channel (e.g., “x-axis”. “y-axis”, “blue”, etc.). The reference may be retrieved for the formula 420 by clicking on the particular visual representation of the channel within the workbook element.

Referencing a channel of a workbook element instead of directly using a reference to the dimension itself enables the workbook element containing the formula to change dynamically with a change of the underlying data set. Specifically, once the dimensions of the new data set are bound to the channels of the workbook element, any formulas that reference those channels need not be rewritten for the new data set, even if the references now refer to entirely different dimensions with different names.

The method of FIG. 4 also includes detecting 406, by the workbook manager 208, that the formula 420 references the channel within the workbook element. Detecting 406 that the formula 420 references the channel within the workbook element may be carried out by evaluating the received formula 420 for a reference to any channel of the workbook element. The workbook manager 208 may further verify that the reference to the channel is valid. Specifically, the workbook manager 208 may check that the referenced channel exists and that the referenced channel is bound to a dimension of the data set.

The method of FIG. 4 also includes rewriting 408, by the workbook manager 208, the formula 420 by replacing the reference to the channel within the workbook element with the first dimension bound to the channel. Rewriting 408 the formula 420 by replacing the reference to the channel within the workbook element with the first dimension bound to the channel may be carried out in response to the detection that the formula 420 references a channel within the workbook element. The formula 420 may be rewritten such that the reference to channel is replaced by a direct reference to the dimension bound to the channel. Rewriting the formula 420 may also include reconfiguring the formula once the reference to the dimension is incorporated (e.g., by rearranging or combining operations and elements). The rewritten formula 420 may then be stored with workbook metadata in a workbook repository.

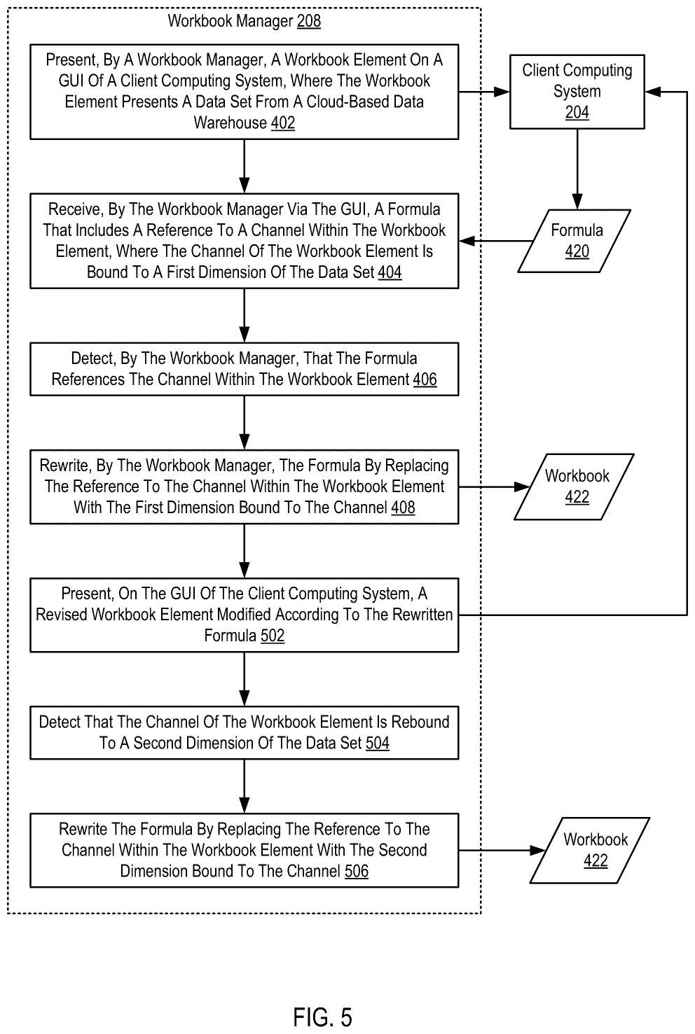

For further explanation, FIG. 5 sets forth a flow chart illustrating a further exemplary method for dynamic dimension binding for workbook elements according to embodiments of the present invention that includes presenting 402, by a workbook manager 208, a workbook element on a GUI of a client computing system 204, wherein the workbook element presents a data set from a cloud-based data warehouse; receiving 404, by the workbook manager 208 via the GUI, a formula 420 that includes a reference to a channel within the workbook element, wherein the channel of the workbook element is bound to a first dimension of the data set; detecting 406, by the workbook manager 208, that the formula 420 references the channel within the workbook element; and rewriting 408, by the workbook manager 208, the formula 420 by replacing the reference to the channel within the workbook element with the first dimension bound to the channel.

The method of FIG. 5 differs from the method of FIG. 4, however, in that the method of FIG. 5 further includes presenting 502, on the GUI of the client computing system 204, a revised workbook element modified according to the rewritten formula; detecting 504 that the channel of the workbook element is rebound to a second dimension of the data set; and rewriting 506 the formula by replacing the reference to the channel within the workbook element with the second dimension bound to the channel.

Presenting 502, on the GUI of the client computing system 204, a revised workbook element modified according to the rewritten formula may be carried out by retrieving the data set for the workbook 422 from the cloud-based data warehouse, including issuing a database statement to the cloud-based data warehouse. Once retrieved, the data set is organized based on the workbook metadata for the workbook and revised workbook element. Finally, the workbook 422 is sent, via a workbook client, to the client computing system 204.

Detecting 504 that the channel of the workbook element is rebound to a second dimension of the data set may be carried out by the workbook client receiving, via the GUI, an indication that the second dimension has been bound to the channel instead of the first channel. Rebinding the channel to the second dimension may include detecting that the client has selected the second dimension and indicated that the second dimension is to replace the first dimension within the workbook element. For example, a first column of the data set may be bound to the y-axis of a bar graph workbook element. A user may subsequently select a second column of the data set to instead be bound to the y-axis of the bar graph.

Rewriting 506 the formula by replacing the reference to the channel within the workbook element with the second dimension bound to the channel may be carried out by replacing the reference to the channel with a direct reference to the second dimension. This may be performed automatically upon detection that the channel has been rebound. Subsequently, the workbook element may be updated to reflect the new binding by, for example, displaying a modified visualization or presenting an altered spreadsheet structure.

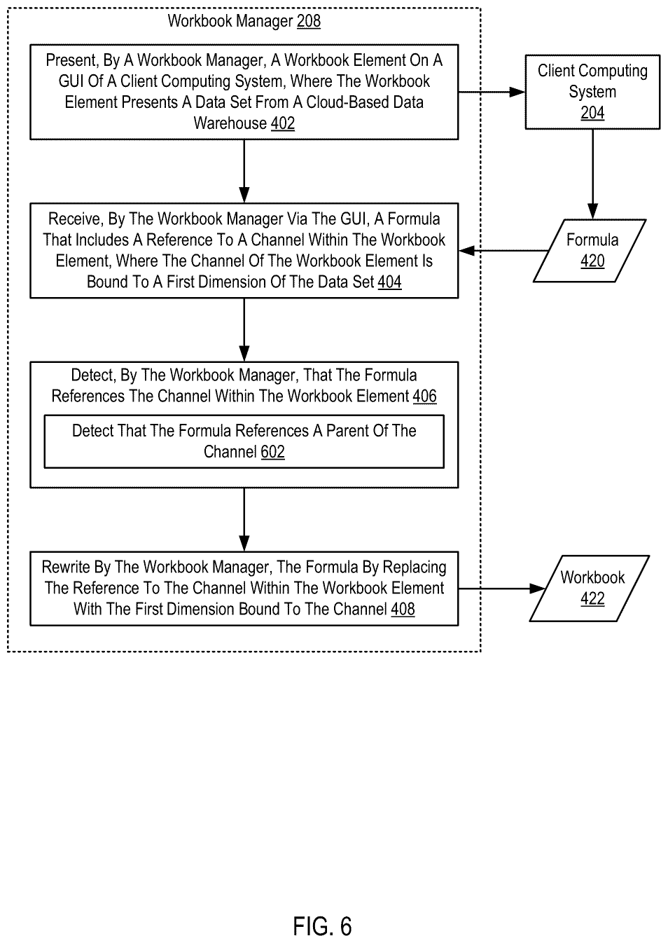

For further explanation, FIG. 6 sets forth a flow chart illustrating a further exemplary method for dynamic dimension binding for workbook elements according to embodiments of the present invention that includes presenting 402, by a workbook manager 208, a workbook element on a GUI of a client computing system 204, wherein the workbook element presents a data set from a cloud-based data warehouse; receiving 404, by the workbook manager 208 via the GUI, a formula 420 that includes a reference to a channel within the workbook element, wherein the channel of the workbook element is bound to a first dimension of the data set; detecting 406, by the workbook manager 208, that the formula 420 references the channel within the workbook element; and rewriting 408, by the workbook manager 208, the formula 420 by replacing the reference to the channel within the workbook element with the first dimension bound to the channel.

The method of FIG. 6 differs from the method of FIG. 4, however, in that detecting 406, by the workbook manager 208, that the formula 420 references the channel within the workbook element includes detecting 602 that the formula 420 references a parent of the channel. Detecting 602 that the formula 420 references a parent of the channel may be carried out by evaluating the received formula 420 for a parental reference to any channel of the workbook element. The parental reference may include the reference to the channel with a generation count indicating a level above the referenced channel. The workbook manager 208 may further verify that the parental reference to the channel is valid. Specifically, the workbook manager 208 may check that the referenced parent channel exists and that the referenced parent channel is bound to a dimension of the data set.

For example, a workbook element may be created presenting a pivot table listing book sales, by region, for product categories. A new column may be created to present a percent of the total for the row count. The formula for the new column may include a reference to the “product type” channel and an indication that the percent total of row count is to be based on the row parent of the “product type” channel. The resulting example workbook element is shown below in Table 1.

TABLE 1

| Store Region/Product Type | % of Total for Row Count (by Row Parent) |
|---|---|
| East | |
| Fiction | 45.8 |
| Non-Fiction | 39.2 |
| How-to | 15 |
| West | |
| Fiction | 41.1 |
| Non-Fiction | 55.8 |
| How-to | 3.1 |
| South | |
| Fiction | 51.0 |
| Non-Fiction | 34.5 |
| How-to | 14.5 |

In view of the explanations set forth above, readers will recognize that the benefits of dynamic dimension binding for workbook elements according to embodiments of the present invention include:
Improving the operation of the computer system by providing a data analytics tool to organize and visualize data sets from a cloud-based data warehouse, increasing system utility.
Improving the operation of the computer system by enabling a workbook element to change dynamically with a change of the underlying data set, increasing system robustness.

Exemplary embodiments of the present invention are described largely in the context of a fully functional computer system for dynamic dimension binding for workbook elements. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for dynamic dimension binding for workbook elements, the method comprising:
presenting, by a workbook manager, a workbook element on a GUI of a client computing system, wherein the workbook element presents a data set from a cloud-based data warehouse;
receiving, by the workbook manager via the GUI, a formula that includes a reference to a channel within the workbook element, wherein the channel of the workbook element is bound to a first dimension of the data set;
detecting, by the workbook manager, that the formula references the channel within the workbook element; and
rewriting, by the workbook manager, the formula by replacing the reference to the channel within the workbook element with the first dimension bound to the channel.

2. The method of claim 1, further comprising:
presenting, on the GUI of the client computing system, a revised workbook element modified according to the rewritten formula.

3. The method of claim 1, further comprising:
detecting that the channel of the workbook element is rebound to a second dimension of the data set; and
rewriting the formula by replacing the reference to the channel within the workbook element with the second dimension bound to the channel.

4. The method of claim 1, wherein the first dimension of the data set is a column.

5. The method of claim 1, wherein detecting that the formula references the channel within the workbook element comprises detecting that the formula references a parent of the channel.

6. The method of claim 1, wherein presenting the workbook element on the GUI of the client computing system comprises issuing a database statement to the cloud-based data warehouse and receiving the data set as query results from the cloud-based data warehouse.

7. The method of claim 1, wherein the workbook element is one element within a workbook presented on the GUI of the client computing system

8. The method of claim 1, wherein the workbook element is one selected from a group consisting of a spreadsheet structure and a data visualization.

9. The method of claim 1, wherein rewriting the formula comprises storing the workbook with the rewritten formula on an intermediary computing system between the client computing system and the cloud-based data warehouse.

10. The method of claim 1, wherein the workbook manager is on a workbook manager computing system between the client computing system and the cloud-based data warehouse.

11. An apparatus for dynamic dimension binding for workbook elements, the apparatus comprising a computer processor, a computer memory operatively coupled to the computer processor, the computer memory having disposed within it computer program instructions that, when executed by the computer processor, cause the apparatus to carry out the steps of:
presenting a workbook element on a GUI of a client computing system, wherein the workbook element presents a data set from a cloud-based data warehouse;
receiving, via the GUI, a formula that includes a reference to a channel within the workbook element, wherein the channel of the workbook element is bound to a first dimension of the data set;
detecting that the formula references the channel within the workbook element; and
rewriting the formula by replacing the reference to the channel within the workbook element with the first dimension bound to the channel.

12. The apparatus of claim 11, wherein the computer program instructions further cause the apparatus to carry out the step of:
presenting, on the GUI of the client computing system, a revised workbook element modified according to the rewritten formula.

13. The apparatus of claim 11, wherein the computer program instructions further cause the apparatus to carry out the steps of:
detecting that the channel of the workbook element is rebound to a second dimension of the data set; and
rewriting the formula by replacing the reference to the channel within the workbook element with the second dimension bound to the channel.

14. The apparatus of claim 11, wherein the first dimension of the data set is a column.

15. The apparatus of claim 11, wherein detecting that the formula references the channel within the workbook element comprises detecting that the formula references a parent of the channel.

16. The apparatus of claim 11, wherein presenting the workbook element on the GUI of the client computing system comprises issuing a database statement to the cloud-based data warehouse and receiving the data set as query results from the cloud-based data warehouse.

17. The apparatus of claim 11, wherein the workbook element is one element within a workbook presented on the GUI of the client computing system

18. The apparatus of claim 11, wherein the workbook element is one selected from a group consisting of a spreadsheet structure and a data visualization.

19. The apparatus of claim 11, wherein rewriting the formula comprises storing the workbook with the rewritten formula on an intermediary computing system between the client computing system and the cloud-based data warehouse.

20. A computer program product for dynamic dimension binding for workbook elements, the computer program product disposed upon a computer readable medium, the computer program product comprising computer program instructions that, when executed, cause a computer to carry out the steps of:
presenting a workbook element on a GUI of a client computing system, wherein the workbook element presents a data set from a cloud-based data warehouse;
receiving, via the GUI, a formula that includes a reference to a channel within the workbook element, wherein the channel of the workbook element is bound to a first dimension of the data set;
detecting that the formula references the channel within the workbook element; and
rewriting the formula by replacing the reference to the channel within the workbook element with the first dimension bound to the channel.
